(19) United States
(12) Patent Application Publication
(10) Pub. No.: US 2013/0069529 A1
(43) Pub. Date: Mar. 21, 2013

(54) ELECTRONIC DEVICE CONTAINING NOISE SHIELD

(71) Applicants: Dudley Allan ROBERTS, Penrose, NC (US); John Keen MATHEWS, Weaverville, NC (US)

(72) Inventors: Dudley Allan ROBERTS, Penrose, NC (US); John Keen MATHEWS, Weaverville, NC (US)

(21) Appl. No.: 13/622,802

(22) Filed: Sep. 19, 2012

Related U.S. Application Data
(60) Provisional application No. 61/537,303, filed on Sep. 21, 2011.

(51) Int. Cl. H01J 1/52

(52) U.S. Cl. 315/85

(57) ABSTRACT

Described herein are embodiments of an electronic device including a conductive noise shielding element. The noise shielding element may be connected to an electronic noise-generating element provided within a housing of the electronic device and may by connected to a source of direct current. The noise shielding element may be provided within the housing of the electronic device and may further be thermally connected to the housing.

### RELATED APPLICATION

This application is based on and claims benefit of U.S. Provisional Application No. 61/537,303, filed Sep. 21, 2011, entitled “Multi-Function Heat Sink Assembly.” A claim of priority to this prior application is hereby made, and the disclosure of this prior application is hereby incorporated by reference.

### FIELD OF THE APPLICATION

The present application relates generally to electronic devices. More specifically, the present application relates to electronic devices with high-power, high-frequency switching components capable of injecting electronic noise into input power lines. In particular, the present application relates to an electronic arc lamp ballast for a High Intensity Discharge (“HID”) lamp incorporating an internal noise shield configured to attenuate such noise.

### BACKGROUND

Electronic devices frequently produce electronic or electromagnetic interference (“EMI”), or noise, which can interrupt, obstruct, or otherwise degrade or limit the performance of other electronic devices. To control the propagation of this noise, the Federal Communications Commission (“FCC”) has placed strict limits on the amount of such noise that may be radiated by electronic devices. For example, with respect to arc lamp ballasts, the limits imposed by the FCC are particularly stringent for noise emitted in the AM and SW radio bands, which span from 450 KHz to 30 MHz. More specifically, the AM radio band spans from 450-1600 KHz.

Continuing to use arc lamp ballasts as a representative example, the noise generated by an electronic arc lamp ballast and thereafter injected into the input power lines emerges primarily as the result of high-speed switching components within two circuits composing the ballast: (1) the power factor correction (“PFC”) circuit and (2) the lamp driver circuit. Transistors from these two circuits are frequently connected to an interior surface of the outer housing of the electronic arc lamp ballast so as to provide for the dissipation of heat. Unfortunately, because the outer housing of the modern electronic arc lamp ballast is typically grounded, an avenue thereby exists for noise generated by the aforementioned PFC and lamp driver circuits to propagate into the input power lines.

To address this difficulty, numerous solutions have previously been proposed. Of most notoriety is the placement of large filter capacitors between the two input power lines and the ground line connected to the outer ballast housing. Such an arrangement allows the capacitors to collectively function as a low-pass filter for the input power lines, thereby shorting high-frequency noise to ground. However, this arrangement also creates a substantial risk of electric shock. Therefore, safety organizations such as Underwriters Laboratories (“UL”) place severe limits on the use of such capacitors, thus limiting their practical utility. In some applications, particularly with respect to medical equipment, these large filter capacitors may be entirely forbidden. As a second option, an in-line, common-mode filter, utilized to suppress differences between the currents carried by the two input power lines, may be utilized to block a portion of the noise transmitted via the two input power lines. However, even while using an in-line, common-mode filter, FCC guidelines remain difficult to satisfy. Thus, the ultimate solution is to block noise at its source, within the electronic device itself.

### SUMMARY

Therefore, described herein are electronic devices aimed at fulfilling the above criteria. In certain aspects, the electronic devices can include an electronic noise-generating element within a housing and a direct current source. The electronic noise-generating element and direct current course can be connected to a conductive shielding element. In certain aspects, the shielding element may be thermally connected to the housing and first and second electrical insulators may be provided. The first insulator may be fixed in the connection between the electronic noise-generating element and the shielding element, and the second insulator may be fixed in the connection between the housing and the shielding element.

### BRIEF DESCRIPTION OF THE DRAWINGS

FIG. 1 shows a perspective view of an exemplary electronic arc lamp ballast 1.

FIG. 2 shows a block circuit diagram of the exemplary electronic arc lamp ballast 1.

FIG. 3A shows a circuit diagram of an exemplary noise filter circuit 20.

FIG. 3B shows a circuit diagram of an exemplary power supply circuit 30.

FIG. 3C shows a circuit diagram of an exemplary lamp driver circuit 40.

FIG. 3D shows a circuit diagram of an exemplary current control circuit 50, an exemplary ignition circuit 60, and an exemplary lamp 70.

FIG. 4 shows a portion of the interior of a typical embodiment of the exemplary electronic arc lamp ballast 1 that lacks noise shield 100.

FIG. 5A shows a portion of the interior of an embodiment of the exemplary electronic arc lamp ballast 1 with noise shield 100.

FIG. 5B shows a portion of the interior of another embodiment of the exemplary electronic arc lamp ballast 1 with noise shield 100.

### DETAILED DESCRIPTION OF THE EMBODIMENTS

Hereinafter, embodiments of an exemplary electronic arc lamp ballast 1 will be explained in more detail with reference to the provided drawings. It is to be understood that, in the description that follows, like elements are marked throughout the specification with like reference numerals. It is to be further understood that the electronic arc lamp ballast 1 described hereinafter is merely exemplary of the electronic devices covered by the instant application and that the scope of the instant application is thus not limited by the disclosed embodiments.

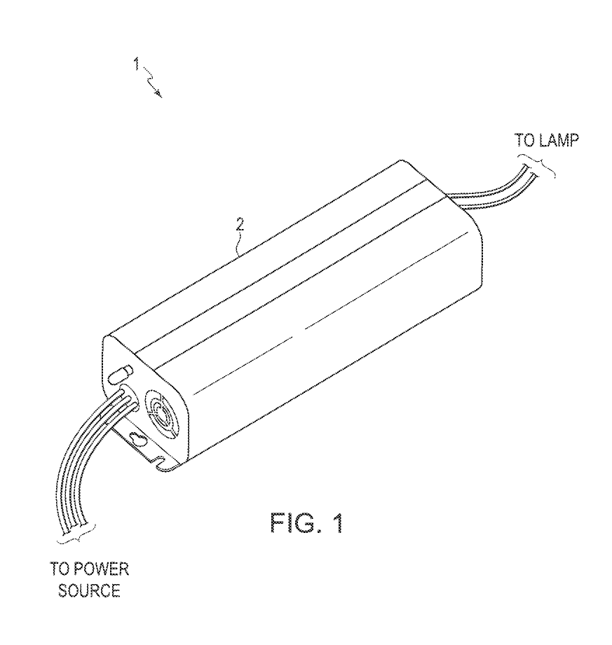

FIG. 1 provides a perspective view of an exemplary embodiment of the electronic arc lamp ballast 1 for a high power arc lamp such as a High Intensity Discharge (“HID”) lamp. As can be seen, the electronic arc lamp ballast 1 can include a housing 2 configured to house and protect various electrical circuits within. As can further be seen from FIG. 1, two input power lines can protrude from the housing 2 toward a source of electrical power, and a ground line, connected to the housing 2, can similarly protrude. Additionally, two output lines can protrude so as to connect the electronic arc lamp ballast 1 to the arc lamp.

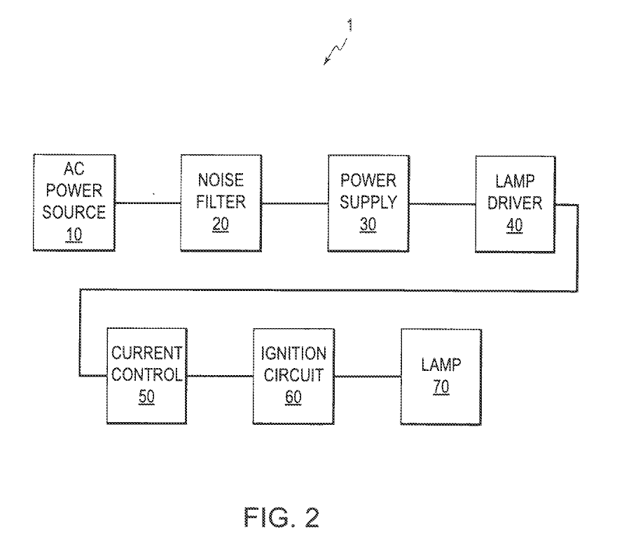

FIG. 2 provides an exemplary block circuit diagram of the electronic arc lamp ballast 1. As can be seen in FIG. 2, the electronic arc lamp ballast 1 can include a noise filter circuit 20, a power supply circuit 30, a lamp driver circuit 40, a current control circuit 50, and an ignition circuit 60. An AC power source 10 can be electrically connected to the noise filter circuit 20, and a lamp 70 can be electrically connected to the ignition circuit 60. In certain aspects, the noise filter circuit 20 is omitted from the electronic arc lamp ballast 1. In certain aspects, the power supply circuit 30 is supplemented with a power factor correction (“PFC”) circuit.

The AC power source 10 is archetypal of that found in many developed countries. In certain aspects, the AC power source 10 operates between 100V and 300V and at frequencies ranging from 50 Hz-60 Hz. More specifically, regions transmitting at 60 Hz, such as the Americas, typically utilize voltages of 120V, 20$V, 240V, or 278V in the non-residential locations where HID lamps are most often employed, and regions transmitting at 50 Hz, such as most of Europe, typically utilize voltages ranging from 220V-240V. Certain locations may run higher wattage lamps at 440V.

The noise filter circuit 20 helps ensure compliance with FCC requirements and, to some extent, maintains stable operation of the electronic arc lamp ballast 1 by separating the AC power source 10 from the latter circuits 30, 40, 50, 60 of the electronic arc lamp ballast 1. To do so, the noise filter circuit 20 may perform two primary functions. First, the noise filter circuit 20 may have the primary function of preventing noise generated by the high-speed switching of inductive circuits internal to the electronic arc lamp ballast 1 from propagating to the two input power lines and thereafter to the AC power source 10. Additionally, the noise filter circuit 20 may have the secondary function of preventing noise transmitted from the AC power source 10, such as that accompanying a supplied over-voltage, from propagating into the electronic arc lamp ballast 1.

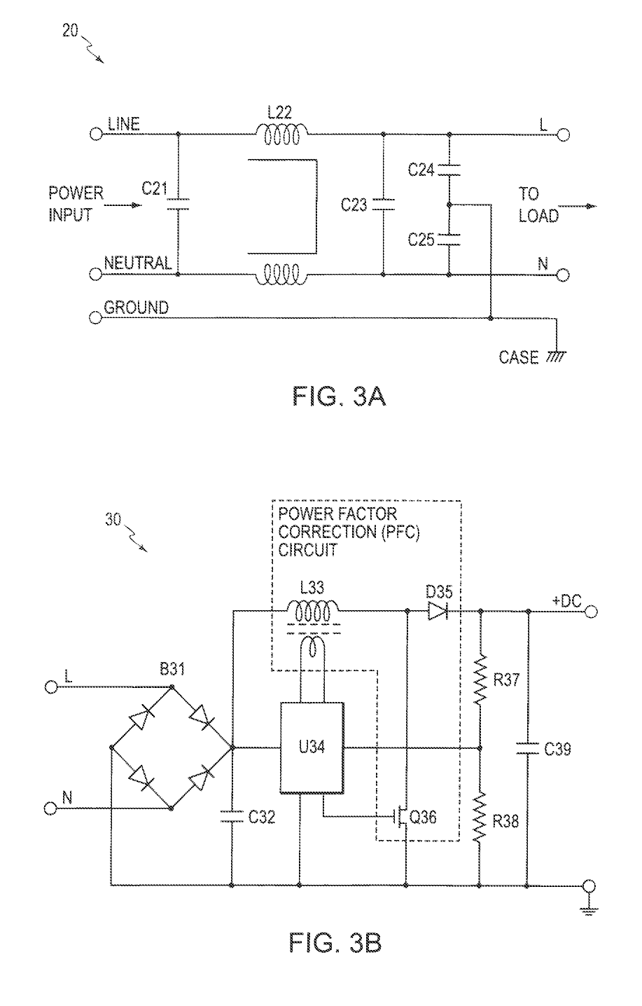

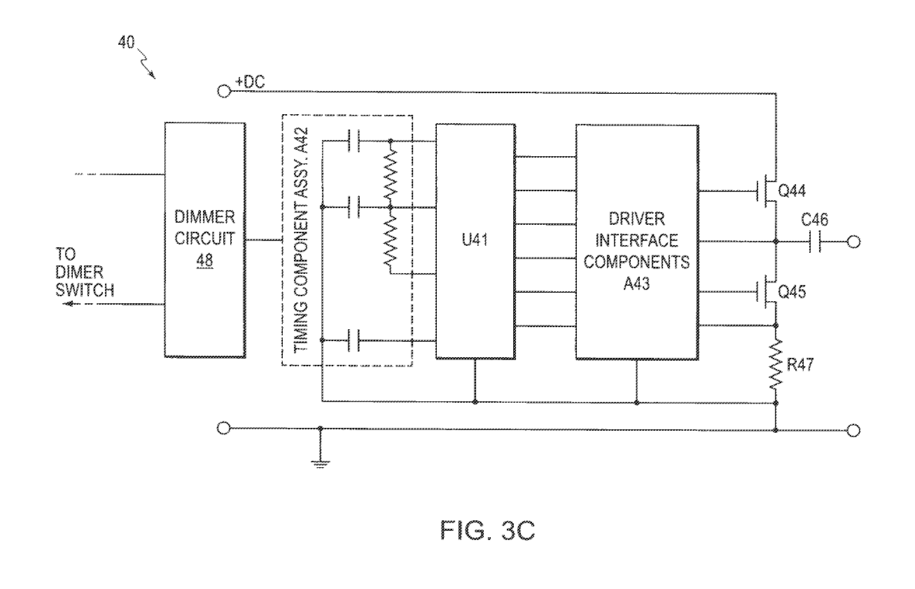

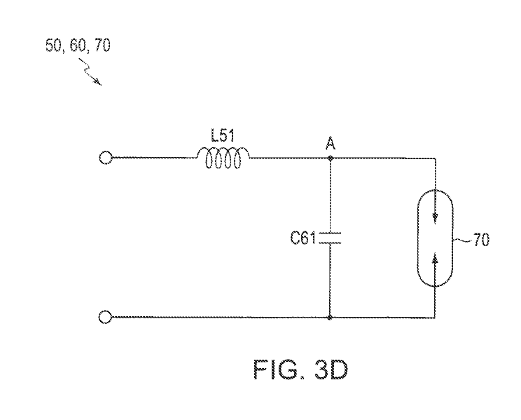

FIG. 3A provides a circuit diagram of an exemplary noise filter circuit 20. As can be seen, the exemplary noise filter circuit 20 includes one or two common-mode inductors L22 and capacitors C21, C23, C24, and C25. In certain aspects, capacitors C21 or C23 may, be omitted from the noise filter circuit 20. In certain aspects, other elements such as a thermistor may be employed. In certain aspects, capacitors C24 and C25 may have very small values or may be omitted entirely.

The power supply circuit 30 outputs a regulated DC voltage to the lamp driver circuit 40. To do so, the power supply circuit 30 may have the primary function of converting the filtered AC power transmitted by the AC power source 10 through the noise filter circuit 20 into DC power via full-wave rectification. However, although the process of full-wave rectification can deliver unidirectional current, this uni-directional current is not produced at a constant voltage. Therefore, in certain aspects, an output filter capacitor is provided so as to function as a smoothing element and thereby produce a largely-steady DC voltage. In certain aspects, a regulator circuit is provided so as to control the voltage. In certain aspects, the power supply circuit 30 also includes a power factor correction circuit. The power factor of a circuit is defined as the ratio of active, real power P transmitted to the load of a circuit to the apparent power S (P/S) in the circuit. In purely resistive circuits, voltage and current waveforms are in phase; however, when reactive loads are present, such as with capacitors and inductors, energy stored in the loads creates a time difference between the current and voltage waveforms, thus rendering the waveforms out of phase and resulting in a lower power factor. A load with a low power factor draws more current than a load with a high power factor for the same amount of useful power transferred. Thus, it is often desirable to increase the power factor of an electrical system. In certain aspects, the addition of a power factor correction circuit to the power supply circuit 30 can increase the power factor of the electronic arc lamp ballast 1 from approximately 80% to approximately 99%.

FIG. 3B provides a circuit diagram of an exemplary power supply circuit 30 incorporating the above-described circuits. Integrated circuit controller U34 performs all the logic functions required to keep the output voltage stable and to maintain the power factor near unity. Diode bridge B31 rectifies the AC input and outputs a raw DC voltage to the capacitor C32. Transistor Q36, inductor L33, and diode D35 together form the power factor correction circuit. Resistors R37 and R38 detect the output voltage and send a sample to the controller U34, thereby allowing the controller U34 to exert control over the output voltage. Finally, capacitor C39 functions as the aforementioned smoothing capacitor, producing a largely-steady DC voltage from the ripple voltage output by the diode bridge B31.

The lamp driver circuit 40 outputs a lamp driving signal to the current control circuit 50. To do so, the lamp driver circuit 40 may have the primary function of generating a high-frequency square wave oscillating at a frequency of from 50 KHz-200 KHz. The frequency output from the lamp driver circuit 40 can vary depending on the running state of the lamp 70. For example, during the ignition operation of the lamp 70, the lamp driver circuit 40 outputs a very high-frequency drive signal, which it then lowers during the running operation of the lamp 70 after ignition. In certain aspects, the lamp driver circuit 40 is configured to raise the output drive frequency so as to dim the lamp 70.

FIG. 3C provides a circuit diagram of an exemplary lamp driver circuit 40 performing the above-described functions. Integrated circuit controller U41 generates the aforementioned drive frequency. In certain aspects, the controller U41 is combined with the controller U34 of the power supply circuit 30, leaving the electronic arc lamp ballast 1 with but one controller, thereby gaining somewhat-improved functionality and decreased size. Power transistors Q44 and Q45, shown to be oriented in a half-bridge configuration, provide the high-frequency driving signal. Assembly A43 contains those circuits necessary to convert the controller outputs to proper gate driving signals. Resistor R47 functions so as to monitor the current in power transistors Q44 and Q45 and to discontinue operation of the controller U41 if the detected current exceeds a predetermined threshold. Capacitor C46 removes the DC part of the output from the lamp driver circuit 40. Such an operation is necessary because, in certain aspects, the lamp 70 requires a pure AC drive signal to operate. Finally, dimmer circuit 48 detects inputs from a dimmer switch and relays such information to the assembly A42.

The current control circuit 50 may have the primary function of limiting the current transmitted to the lamp 70. Moreover, the current control circuit 50 may have the secondary function of resonating with the ignition circuit 60 at the ignition frequency, thereby generating a very high voltage adequate to ignite the lamp 70. In certain aspects, such as that presented in FIG. 31), the current control circuit 50 is a discrete inductor with a non variable inductance value that is selected for use in a particular lighting application. In certain aspects, the current control circuit 50 is a programmable inductor including a plurality of selectable inductance values. In certain aspects, the current control circuit 50 is a plurality of inductors, each having a different inductance value to be paired with a corresponding lamp 70. In certain aspects, the ignition circuit 60 is simply a capacitor. With reference to FIG. 3D, inductor L51 serves as the current control circuit 50 and capacitor C61 serves as the ignition circuit 60.

The lamp 70 may be a high power arc lamp in which light is produced by means of an electrical arc between electrodes housed within an arc tube. The tube of the arc lamp may be filled with both a gas that facilitates the arcs initial strike as well as metal salts which, once the arc is ignited, evaporate and thereby form a plasma. The lamp 70 can be rated for a certain wattage in the range of SOW to 2000 W, the certain wattage of the lamp 70 matching that provided by the current control circuit 50. In certain aspects, the lamp 70 possesses a rating in the most common range of 250 W-400 W. In certain aspects, the lamp 70 possesses a less common rating of 150 W, 175 W or 320 W. In certain aspects, the electrodes of the lamp 70 are formed of tungsten. In certain aspects, the tube of the lamp 70 is formed of fused quartz. In certain aspects, the tube of the lamp 70 is formed of fused alumina. In certain aspects, the lamp 70 is a High Intensity Discharge (“HID”) lamp. In certain aspects, the HID lamp 70 is a mercury vapor lamp. In certain aspects, the HID lamp 70 is a metal halide lamp. In certain aspects, the HID lamp 70 is a low-pressure sodium vapor lamp. In certain aspects, the HID lamp 70 is a high-pressure sodium vapor lamp.

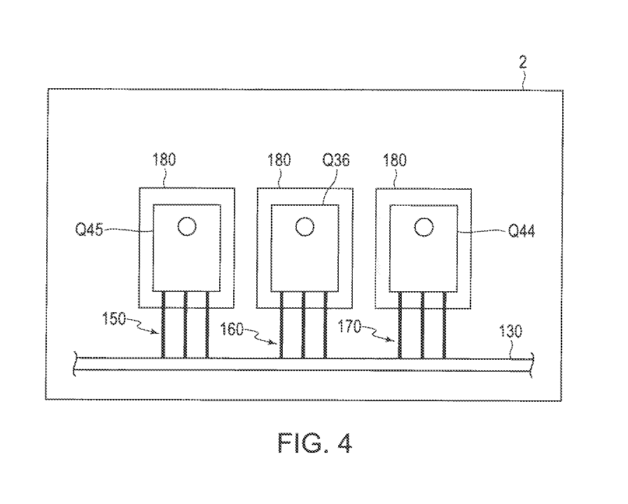

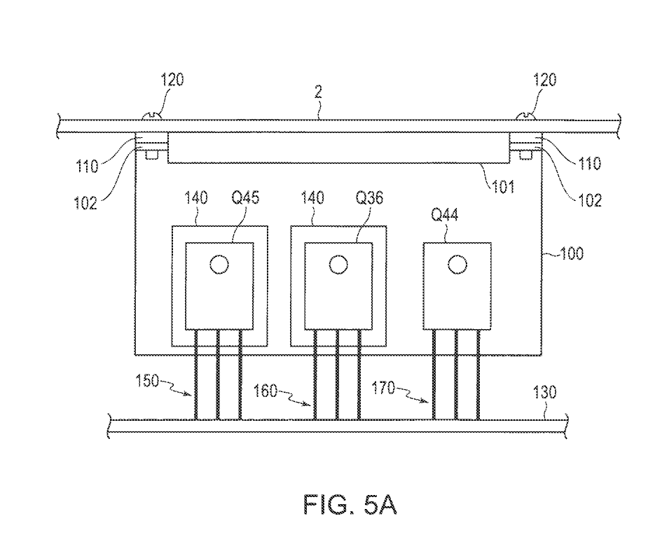

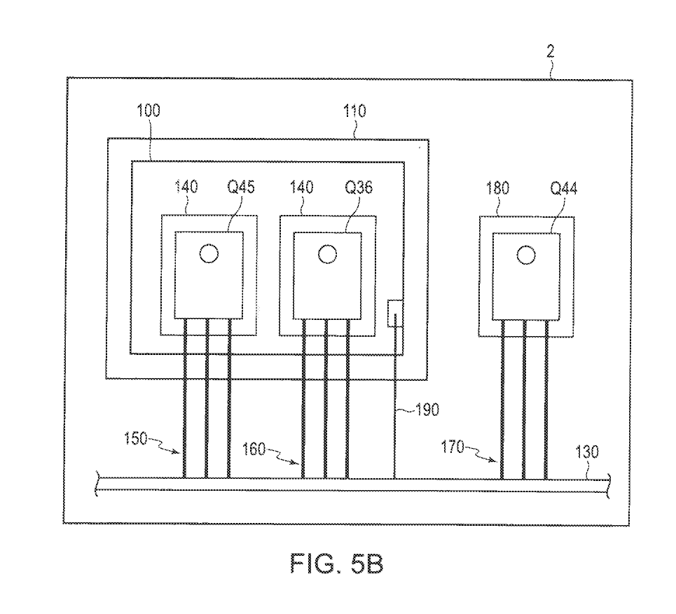

FIG. 4 provides a typical embodiment of a portion of the interior of the electronic arc lamp ballast 1. As with FIGS. 5A and 5B discussed below, elements of the electronic arc lamp ballast 1 not necessary to understand the disclosed embodiment are not illustrated in FIG. 4. As can be seen from FIG. 4, a circuit card assembly 130 can be provided within the interior space formed by the housing 2. The circuit card assembly 130 may include any combination of the following: the noise filter circuit 20, the power supply circuit 30, the lamp driver circuit 40, the current control circuit 50, and the ignition control circuit 60. In the embodiment illustrated in FIG. 4, the circuit card assembly 130 includes at least the power supply circuit 30 and the lamp driver circuit 40. From the circuit card assembly 130, the second lamp driver transistor Q45, the power supply transistor Q36, and the first lamp driver transistor Q44 can each be connected to the housing 2 via a metallic backing connected to an electrode of each transistor. Finally, with further reference to FIG. 4, transistor insulators 180, composed of a polyimide plastic such as Kapton® in certain aspects, can be positioned between each of the transistors Q45, Q36, and Q44 and the housing 2, thereby electrically isolating the transistors from the housing 2 as well as from each other.

Such connections are necessary to shunt heat generated by the transistors Q45, Q36, and Q44 toward the metallic housing 2 and thereafter into the surrounding environment. However, such connections also ensure that any signal generated by the transistors Q45, Q36, and Q44 on the aforementioned electrode of each transistor connected to the metallic backing is capacitively coupled directly to the housing 2. Moreover, as previously explained, since the housing 2 of the modern electronic arc lamp ballast 1 is connected to the ground line, the signals generated by the transistors Q45, Q36, and Q44 become noise on the ground line, bypassing any common-mode filter fixed between the two input power lines.

Thus, FIG. 5A provides an exemplary embodiment of a portion of the interior of the electronic arc lamp ballast 1 directed at solving such noise transmission problems. As can be seen, in this embodiment, a noise shield 100 can be provided within the interior space formed by the housing 2. The structure and composition of the noise shield 100 is not particularly limited. In certain aspects, the noise shield 100 may be formed out of aluminum, which is a desirable material because it is a quality conductor of both heat and electricity and is easily machined.

With further reference to FIG. 5A, the circuit card assembly 130 can once again be provided within the interior space aimed by the housing 2. However, in this embodiment, the second lamp driver transistor Q45, being a problematic noise-generating element primarily due to its drain being connected to the driver assembly A43, and the power supply transistor Q36, also being a problematic noise-generating element, can each be connected to the noise shield 100. In certain aspects, the leads 150 and 160, respectively connecting the circuit card assembly 130 to the transistors Q45 and Q36, are sufficiently substantial so as to support the circuit card assembly 130. Thus, in certain aspects, the circuit card assembly 130 may be supported solely by the noise shield 100. In certain other aspects, the circuit card 130 may be supported at other locations by various mechanical mounts. Furthermore, transistor insulators 140, composed of a polyimide plastic such as Kapton® in certain aspects, can be positioned between the transistor Q45 and the noise shield 100 as well as between the transistor Q36 and the noise shield 100, thereby electrically isolating the transistors Q45 and Q36 from the noise shield 100.

With yet further reference to FIG. 5A, the first lamp driver transistor Q44, having its drain directly connected to the highly-filtered DC output of the power supply circuit 30 and thereby carrying very little signal or noise, can be directly connected to the noise shield 100. In certain aspects, the leads 170 of the transistor Q44 are sufficiently substantial to aid in the support of the circuit card assembly 130. Alternatively, in certain aspects, a conductive wire 190 (illustrated in FIG. 5B) may connect the DC output node of the lamp driver circuit 40 to the noise shield 100. In certain other aspects, the conductive wire 190 may connect the ground node of the lamp driver circuit 40 to the noise shield 100. As one can surmise from the foregoing discussion, the origin of the DC signal input to the noise shield 100 is not particularly limited and may be obtained from locations other than the circuit card assembly 130. Accordingly, it is to be understood that the above embodiments are merely exemplary and are not intended to limit the scope of this application.

With final reference to FIG. 5A, the noise shield 100 can be fixed to an interior surface of the housing 2 via lips 102. Insulators 110, composed of a polyimide plastic such as Kapton® in certain aspects, can be provided in the connection between the lips 102 and the housing 2 so as to electrically isolate the source of DC signal, the transistor Q44 in FIG. 5A, from the housing 2. In certain aspects, a cut-out region 101 can be formed in the noise shield 100, thus reducing the contact area between the noise shield 100 and the housing 2 and thereby preventing the introduction of other noise sources onto the ground line connected to the housing 2. In certain aspects, non-conductive fasteners 120 such as nylon screws can be utilized to secure the noise shield 100 to the housing 2, thereby further electrically isolating the noise shield 100 and the elements connected thereto from the housing 2. Thus, by connecting the noise shield 100 to the housing 2, the noise shield 100 is able to effectively serve as part of the heat sinking mechanism for the transistors Q36, Q44 and Q45 by siphoning heat generated by these elements toward the metallic housing 2 so as to thereafter be radiated into the surrounding environment. Furthermore, because of the incorporation of the DC signal from the transistor Q44, very little noise from the transistors Q36 and Q45 is coupled to the housing 2, thereby solving the noise problem of the typical embodiment illustrated in FIG. 4.

FIG. 5B provides another exemplary embodiment of a portion of the interior of the electronic arc lamp ballast 1. The noise shield 100, formed as a thin metal plate in this embodiment, can once again be provided within the interior space formed by the housing 2. Furthermore, the second lamp driver transistor Q45 and the power supply transistor Q36 can once again each be connected to the noise shield 100, and insulators 140 can once again be positioned between the transistor Q45 and the noise shield 100 and between the transistor Q36 and the noise shield 100, thereby electrically isolating the transistors Q45 and Q36 from the noise shield 100.

However, in this embodiment, the conductive wire 190 can be employed so as to provide a DC signal to the noise shield 100, thereby allowing the area of the surface of the noise shield 100 facing the reader to be substantially reduced. In certain aspects, the surface of the noise shield 100 facing the reader possesses an area substantially equivalent to the combined areas of the insulators 140. Additionally, as may also be seen in FIG. 5B, the insulator 110, once again composed of a polyimide plastic such as Kapton® in certain aspects, can be provided between the noise shield 100 and the housing 2, thereby electrically isolating the source of DC signal, the wire 190 in FIG. 5B, from the housing 2. Furthermore, the first lamp driver transistor Q44 can be fixed to the housing 2, thereby allowing heat to be shunted away from the transistor Q44 and toward the housing 2. Finally, insulator 180 can be provided between the transistor Q44 and the housing 2, thereby electrically isolating the transistor Q44 from the housing 2.

By placing the noise shield 100 in close contact with the housing 2, the noise shield 100 is able to effectively conduct heat generated by the transistors Q45 and Q36 to the housing 2, thus allowing the housing 2 to serve effectively as a heat sink. Furthermore, because of the incorporation of the DC signal from the wire 190, very little noise from the transistors Q36 and Q45 is coupled to the housing 2, thereby once again solving the noise problem of the typical embodiment illustrated in FIG. 4. In summation, by arranging the described elements in a manner such as that of the previously-discussed embodiments illustrated in FIGS. 5A and 5B, heat generated by the transistors Q36, Q44 and Q45 may be effectively disposed of while simultaneously preventing the propagation of noise generated by the transistors Q36 and Q45 to the ground line connected to the housing 2.

| Numeral | Element |
|---|---|
| 1 | Electronic Arc Lamp Ballast |
| 2 | Ballast Housing |
| 10 | AC Power Source |
| 20 | Noise Filter Circuit |
| 21 | 1^{st} Noise Filter Capacitor |
| 22 | Noise Filter Inductor |
| 23 | 2^{nd} Noise Filter Capacitor |
| 24 | 3^{rd} Noise Filter Capacitor |
| 25 | 4^{th} Noise Filter Capacitor |
| 30 | Power Supply Circuit |
| 31 | Power Supply Diode Bridge |
| 32 | 1^{st} Power Supply Capacitor |
| 33 | Power Supply Inductor |
| 34 | Power Supply Circuit Controller |
| 35 | Power Supply Diode |
| 36 | Power Supply Transistor |
| 37 | 1^{st} Power Supply Resister |
| 38 | 2^{nd} Power Supply Resister |
| 39 | 2^{nd} Power Supply Capacitor |
| 40 | Lamp Driver Circuit |
| 41 | Lamp Driver Circuit Controller |
| 42 | 1^{st} Lamp Driver Assembly |
| 43 | 2^{nd} Lamp Driver Assembly |
| 44 | 1^{st} Lamp Driver Transistor |
| 45 | 2^{nd} Lamp Driver Transistor |
| 46 | Lamp Driver Capacitor |
| 47 | Lamp Driver Resister |
| 48 | Dimmer Circuit |
| 50 | Current Control Circuit |
| 51 | Current Control Inductor |
| 60 | Ignition Circuit |
| 61 | Ignition Capacitor |
| 70 | Lamp |
| 100 | Noise Shield |
| 101 | Noise Shield Cut-Out |
| 102 | Noise Shield Lip |
| 110 | Shield-Housing Insulator |
| 120 | Non-Conductive Fastener |
| 130 | Circuit Card Assembly |
| 140 | Transistor-Shield Insulator |
| 150 | Q45 Leads |
| 160 | Q36 Leads |
| 170 | Q44 Leads |
| 180 | Transistor-Housing Insulator |
| 190 | Conductive Wire |

What is claimed is:

1. An electronic device comprising:
a housing;
an electronic noise-generating element provided within the housing;
a direct current source; and
a conductive shielding element connected to the electronic noise-generating element and to the direct current source.

2. The electronic device of claim 1, wherein the shielding element is provided within the housing and is thermally connected to the housing.

3. The electronic device of claim 2, further comprising:
a first electrical insulator fixed in the connection between the electronic noise-generating element and the shielding element.

4. The electronic device of claim 3, further comprising:
a second electrical insulator fixed in the connection between the housing and the shielding element.

5. The electronic device of claim 4, wherein the direct current source is provided within the housing.

6. The electronic device of claim 2, wherein the shielding element is configured to support a circuit card assembly provided within the housing.

7. The electronic device of claim 2, wherein the shielding element is connected to the housing at connection points, and
wherein a cut-out portion is formed in the shielding element between the connection points.

8. An electronic arc lamp ballast comprising:
a housing;
an electronic noise-generating element provided within the housing;
a direct current source; and
a conductive shielding element connected to the electronic noise-generating element and to the direct current source.

9. The electronic arc lamp ballast of claim 8, wherein the shielding element is provided within the housing and is thermally connected to the housing.

10. The electronic arc lamp ballast of claim 9, further comprising:
a first electrical insulator fixed in the connection between the electronic noise generating element and the shielding element.

11. The electronic arc lamp ballast of claim 10, further comprising:
a second electrical insulator fixed in the connection between the housing and the shielding element.

12. The electronic arc lamp ballast of claim 11, wherein the direct current source is provided within the housing.

13. The electronic arc lamp ballast of claim 12, wherein the direct current source is output from a power supply circuit of the electronic arc lamp ballast.

14. The electronic arc lamp ballast of claim 12, wherein the direct current source is provided from a lamp driver circuit of the electronic arc lamp ballast.

15. The electronic arc lamp ballast of claim 12, wherein the electronic noise generating element comprises a power factor correction circuit of the electronic arc lamp ballast.

16. The electronic arc lamp ballast of claim 12, wherein the electronic noise-generating element comprises a lamp driver circuit of the electronic arc lamp ballast.

17. The electronic arc lamp ballast of claim 9, wherein the shielding element is configured to support a circuit card assembly provided within the housing.

18. The electronic arc lamp ballast of claim 9, wherein the shielding element is connected to the housing at connection points, and
wherein a cut-out portion is formed in the shielding element between the connection points.
